(19) United States
(12) Patent Application Publication
(10) Pub. No.: US 2010/0243757 A1
(43) Pub. Date: Sep. 30, 2010

(54) DEVICE FOR POSITIONING SPRAY-GUN AIR CAP

(76) Inventors: Takayuki Hata, Yokohama-shi (JP); Hironobu Kasio, Yokohama-shi (JP)

Correspondence Address: WENDEROTH, LIND & PONACK, L.L.P., 1030 15th Street, N.W.,, Suite 400 East, Washington, DC, 20005-1503, US

(21) Appl. No.: 12/748,611

(22) Filed: Mar. 29, 2010

(30) Foreign Application Priority Data
Mar. 31, 2009 (JP) U 2009-1965

(51) Int. Cl. B05B 1/28

(52) U.S. Cl. 239/290

(57) ABSTRACT

There is provided a device capable of selecting quickly and simply either vertical or horizontal spray pattern. It is a spray-gun air cap positioning device, wherein on the inner surface of an air cap (3), facing the front end face (11) of a spray gun body (1) to which the air cap (3) is to be attached, there are provided two pins A on a circle concentric with the air cap (3); on the front end face of the gun body (1), there is provided a pin B on a circle generally concentric with the circle on which the pins A are provided; the pins A and pin B are of such lengths that when the air cap (3) is attached to the gun body (1), the pins A and B will abut on each other to limit the air cap (3) from being further turned; and each of the pins A and B is provided in such a position that the air cap (3) can be turned through an angle of 90 deg. defined between a position where any one of the pins A1 (or A2) at the air cap (3) is limited by the pin B at the gun body (1) from being further turned and a position where the other pin A2 (or A1) is limited by the pin B from being further turned.

### TECHNICAL FIELD

The present invention relates to a device for positioning an atomization air cap of an air spray gun that uses compressed air to atomize paint or the like and sprays the atomized paint to an object to be coated.

### BACKGROUND ART

The air spray gun that uses compressed air to atomize paint or the like for spray coating is normally designed to spread the pattern of spraying into an elliptic or elongated form for efficiently forming a uniform coating of the paint on an object. Thus, in case the spray gun is operated while being held by hand or in case it is moved while being held as installed on an automatic coater, coating is made with the spray gun being moved in a direction perpendicular to a direction in which the spray pattern is to be spread.

Also, for simpler operation and movement of a prevailing ordinary spray gun, the air cap is rotatably installed to the spray gun to change the direction of the spray pattern. Generally, most of the air spray guns are used with the spray pattern being spread horizontally or vertically. Thus, the spray gun is used with the air cap set in either such a horizontal or vertical direction. For an efficient coating corresponding to the shape of a surface to be coated of an object, the painting worker using the spray gun sets a direction of the air cap for a vertically extending spray pattern when he or she intends to coat the object by moving the spray gun mainly in the horizontal direction, and in case it is better to move the spray gun vertically, he will change the direction of the air cap for a horizontally extending spray pattern.

It is desirable to install the air cap correctly because wrong positioning thereof will adversely affect the finish of coating. Especially, to maintain and stabilize the quality of coating in automatic coating, it is necessary to install the spray gun on an automatic coater or coating robot and operate it correctly by means of the coater or robot so that the spray gun can be positioned correctly relative to a to-be-coated object and always make stable paint spraying to the object.

On this account, it was proposed in the Japanese Published Unexamined Utility Model Application No. 63061 of 1984(58-63061) that for quick and accurate repositioning of the air cap, a pin is provided on the air cap and two holes are so formed in the body of a spray gun to which the air cap is to be attached as to define a phase angle of 90 deg. between them, the pin on the air cap being inserted in any one of the two holes formed in the spray gun body when the air cap is attached to the spray gun so that the air cap can be positioned correctly.

Also, it was proposed as specified in the Gazette containing the registered Japanese Utility Model No. 3110753 that a pin is provided on the body of the spray gun and recesses in any one of which the pin is to be engaged are formed in positions of which the rotational angle is 90 deg. in an air cap which is to be used with the spray gun.

In the above-mentioned proposals, the pin, holes and recesses are effective for correct positioning of the air cap. For changing the direction of a spray pattern, however, the painting worker has to loosen, to the full extent, or detach the air cap, and then reattach it with the pin aligned with the hole or recess. That is, no immediate changing of the spray pattern direction is possible. Therefore, setting a direction of the spray pattern takes time and thus the painting worker has to discontinue the painting operation being done, which leads a problem for the productivity of coating.

It is therefore desirable that the direction of a spray pattern defined by the air cap can be changed instantaneously and correctly with little discontinuity of a painting operation and the painting operation once discontinued be quickly resumed with a spray pattern corresponding to an object to be coated. The present invention is intended to overcome the above-mentioned drawbacks of the related art by providing a spray-gun air cap positioning device that permits to change the spray pattern quickly to a horizontally or vertically extending one in the course of a painting operation.

### SUMMARY OF THE INVENTION

According an embodiment of the present invention there is provided a spray-gun air cap positioning device, wherein on the inner surface of an air cap, facing the front end face of a spray gun body to which the air cap is to be attached, there are provided two pins A on a circle concentric with the air cap; on the front end face of the gun body, there is provided a pin B on a circle generally concentric with the circle on which the pins A are provided; the pins A and pin B are of such lengths that when the air cap is attached to the gun body, the pins A and B will abut on each other to limit the air cap from being further turned; and each of the pins A and B is provided in such a position that the air cap can be turned through an angle of 90 deg. defined between a position where any one of the pins A at the air cap is limited by the pin B at the gun body from being further turned and a position where the other pin A is limited by the pin B from being further turned. The pin B on the gun body is previously fixed in a position where the spray pattern is vertical or horizontal.

According to the present invention, the air cap is to be attached to the gun body with the pin B on the gun body being placed between the two pins A on the air cap. The air cap can be turned through an angle of 90 deg. defined between a position where the air cap is limited from being further turned after having been turned in one direction with the pin A abutting on the pin B and a position where it is similarly limited from being further turned after having been turned in a direction opposite to the one direction, whereby a vertical spray pattern and a horizontal one can be easily selected.

The air cap can be selectively positioned for a horizontal or vertical spray pattern based on the position of the pin B previously fixed on the gun body and hence the painting worker has not to visually check whether the spray pattern is horizontal or vertical. Therefore, the air cap can be quickly repositioned for either the horizontal or vertical spray pattern. Namely, the air cap can be positioned extremely easily and correctly. Also, the manufacturing costs can be cut considerably because it is simply needed to form holes in place in the air cap and gun body and fix the pins in the respective holes.

### BRIEF DESCRIPTION OF THE DRAWINGS

The present invention will be described in detail concerning the embodiment thereof with reference to the accompanying drawings, in which:

FIG. 1 is a sectional view of an air cap attached to the front end of a gun body with a cover;

FIG. 2 is a view, from inside, of the air cap shown in FIG. 1;

FIG. 3 is a sectional view, taken along the line D-D, of the air cap shown in FIG. 2: and

FIG. 4 is an explanatory drawing of the air cap shown in FIG. 2 and which is turned clockwise through 90 deg.

### DETAILED DESCRIPTION OF THE INVENTION

The painting air spray gun uses compressed air to atomize paint ejected from the front-end center thereof. Normally, conditioned compressed air is ejected from either side of the spray gun in addition to the atomization compressed air ejected from the front-end center to spread the spray pattern flatly into an elliptic or elongated form.

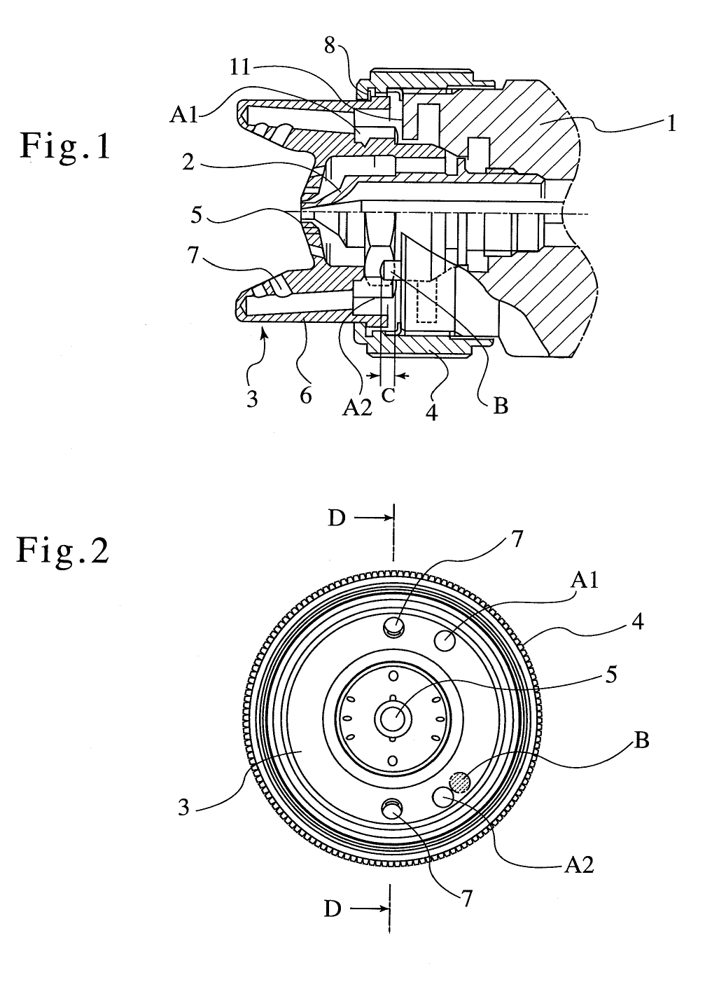

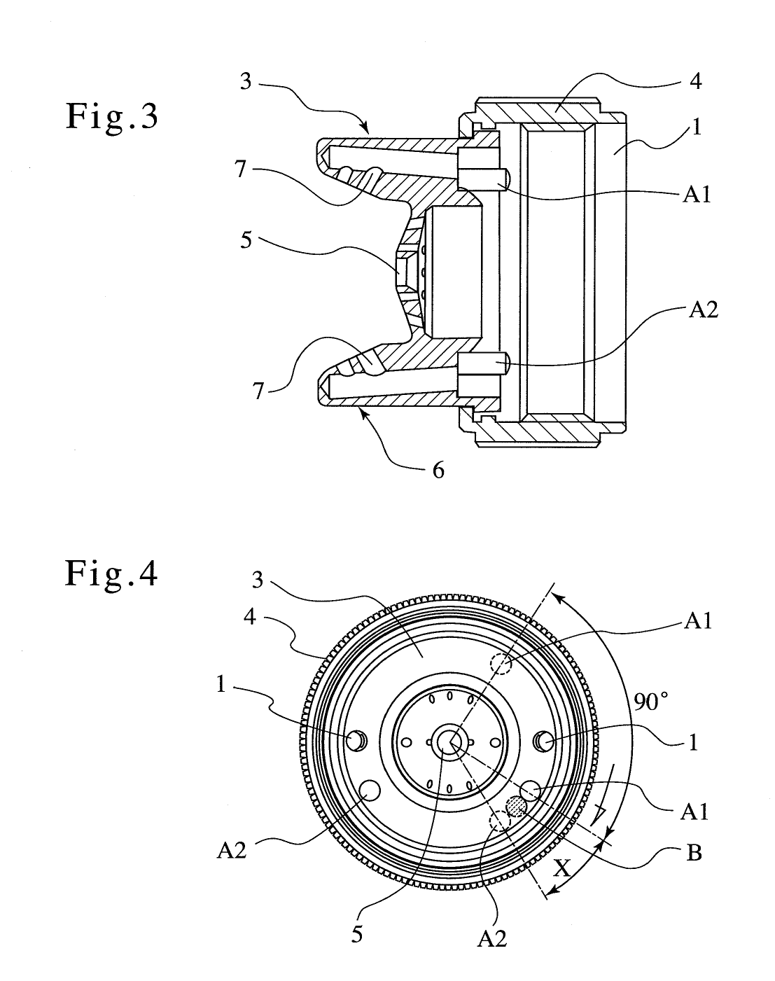

FIG. 1 shows only the front-end portion of a gun body 1. As shown, a paint nozzle 2 is provided in the center of the gun body 1, and an air cap 3 is removably attached to the free end of the paint nozzle 2 with a cover 4. The air cap 3 has a central atomization air outlet 5 and conditioning air outlets 7 formed in a salient horn 6 on either side of the central air outlet 5 to be diametrically opposite to each other. This is well-known as the atomizer of the prevailing air spray guns.

When the air cap 3 is turned until the conditioning air outlets 7 in the horn 6 come onto a vertical line as shown in FIG. 1, the conditioned compressed air ejected from the opposite conditioning air outlets 7 will join the central atomization air and spreads the latter up and down, so that the spray pattern will take a horizontally extending elliptic or elongated form. Likewise, when the air cap 3 is turned until the air outlets 7 in the horn 6 come onto a horizontal line, the spray pattern will take a vertically extending elliptic or elongated form. In some conventional air spray guns, the air cap (namely, the horn) cannot be easily turned if the cover remains too tightly closed. In such a case, the cover has to be loosened a little. According to the present invention, however, a packing 8 is provided under the flange of the cover 4 for easier turn of the cover 4 to turn the air cap 3 (horn 6) without the necessity of loosening the cover 4.

As shown in FIGS. 1 and 2, two pins A1 and A2 are provided on the inner surface of the air cap 3 in two places facing the front-end face 11 of the gun body 1. The two pins A1 and A2 are located on a circle concentric with the air cap 3 so that the angle formed between the lines extending through the pins A1 and A2 and the center of the air cap 3 is somewhat larger by the diameter of the pins A1 and A2 than 90 deg.

On the other hand, on the part of the gun body 1, there is provided a pin B on a circle generally concentric with that on which the two pins A1 and A2 are provided on the part of the air cap 3. These pins A and B are fixed in place by driving with their end portions being projected. Their positioning is best shown in FIG. 4. That is, the pins A and B are provided in such a geometrical relation that when the air cap 3 is attached to the gun body 1, the pin B will be positioned between the two pins A, and that the pins A and B axially abut on each other in such a range C (as shown in FIG. 1) that when the air cap 3 is turned, the pin A (A1 or A2) will abut on the pin B and be thus blocked by the latter from further being moved.

Further, the pin B is fixed in a position shown as hatched in FIG. 4, while the pins A fixed on the air cap 3 are movable relative to the pin B at the part of the gun body 1 when the air cap 3 is turned. FIG. 4 shows a position in which the pin A indicated with a solid line having been moved by turning the air cap 3 in the direction of arrow abuts on the pin B and is thus limited by the latter from being further moved. In this case, the conditioning air outlets 7 in the horn 6 of the air cap 3 are positioned on a horizontal line for a horizontal elliptic or elongated spray pattern.

When the air cap 3 is turned counterclockwise from the above position, the pin A2 indicated with a solid line will abut on the pin B and be thus stopped in a position indicated with a chain line. The pins A1 and A2 are provided in such positions that the pin A1 will be turned through an angle of 90 deg. at this time. More specifically, the pins A1 and A2 are provided to define, with the center of the air cap 3, a sum of the angle of 90 deg. and an additional angle X equivalent to the sum of diameters of the pins A and B lying on the circle on which they are provided. Thus, the positions of the pin A, indicated with the chain line and solid line respectively, maintain exactly the angle of 90 deg. between them, and the air cap 3 is limited from being further turned when the conditioning air outlets 7 in the horn 6 are positioned on a horizontal or vertical line.

It should be noted here that the position of the pin B is not limited to that specified in the aforementioned embodiment but may be appropriately provided in any other place where any inconvenience will not be caused and the pins A are to be provided on the air cap 3 in positions corresponding to the position of the pin B. That is, the pins may be provided in such respective positions that when turned to a position for horizontal or vertical spray, the air cap can be limited from being further turned. Also note that although a single pin is provided on the part of the gun body in the aforementioned embodiment, two pins may be provided instead on the part of the gun body while a single pin may be provided on the part of the air cap. This variation is effective similarly to the pins A and B provided in the embodiment.

1. A spray-gun air cap positioning device, wherein on the inner surface of an air cap (3), facing the front end face (11) of a spray gun body (1) to which the air cap (3) is to be attached, there are provided two pins A on a circle concentric with the air cap (3); on the front end face (11) of the gun body (1), there is provided a pin B on a circle generally concentric with the circle on which the pins A are provided; the pins A and pin B are of such lengths that when the air cap (3) is attached to the gun body (1), the pins A and B will abut on each other to limit the air cap (3) from being further turned; and each of the pins A and B is provided in such a position that the air cap (3) can be turned through an angle of 90 deg. defined between a position where any one of the pins A at the air cap (3) is limited by the pin B at the gun body (1) from being further turned and a position where the other pin A is limited by the pin B from being further turned.
